(19) United States
(12) Patent Application Publication
(10) Pub. No.: US 2006/0282368 A1
(43) Pub. Date: Dec. 14, 2006

(54) Adaptive stochastic transaction system

(76) Inventors: Henry Cai, Laguna Hills, CA (US); Fan Luo, Anaheim, CA (US)

Correspondence Address: CHRISTIE, PARKER & HALE, LLP, PO BOX 7068, PASADENA, CA, 91109-7068, US

(21) Appl. No.: 11/451,856

(22) Filed: Jun. 12, 2006

Related U.S. Application Data
(60) Provisional application No. 60/689,307, filed on Jun. 10, 2005.

(51) Int. Cl. G06Q 40/00

(52) U.S. Cl. 705/37

(57) ABSTRACT

A trading system employing an adaptive stochastic transaction system is provided in which a first party is disposed to propose an object offer to a second party, which is disposed to accept the object offer. A marketing communication link couples the vendor and the vendee, whereby the vendor and the vendee communicate data relative to an object offer. A distribution channel may be incorporated for providing a perceivable indication of the object to be offered so that the vendor may propose the object offer to the vendee through the communication link and wherein the data relative to an object offer includes a quasi-stochastic tuple related to the offer value and wherein the vendee is induced to accept the object offer having the offer value being one of generally equal to and less than the purchase value.

### CROSS-REFERENCE TO RELATED APPLICATION

This is an ordinary application of provisional application Ser. No. 60/689,307, filed Jun. 10, 2005, the contents of which are expressly incorporated herein by reference as if set forth in full.

A trading system employing an adaptive stochastic transaction system is provided in which a first party is disposed to propose an object offer to a second party, which is disposed to accept the object offer.

### BACKGROUND

Trading systems are well known in the art and include eBay and the QVC home shopping network. Generally speaking, a trading system consists of a first party offering an object to a second party, which has the option of accepting the offered object at the offered price. The offered price may be a fixed price, an upwardly trending price sold to a highest bidder (English auction), a sealed-bid auction, or a downwardly trending price (Dutch auction). A trading system not only provides a useful service or function, by providing a transaction medium between two different parties, it is part entertaining as it provides a stimulating and enjoyable experience.

Although the prior art trading systems are effective and have generated millions if not billions in annual sales, they do not include a stochastic element over communication channels for conducting a transaction as described herein.

### SUMMARY

The present invention may be implemented by providing a trading system comprising: a computer for establishing an offer value for an object offer, said offer value includes a quasi-stochastic tuple related to the establishment of the offer value; a database for processing a response linked to the object offer at the offer value; and a marketing communication link for conveying the object offer at the offer value.

Another aspect of the invention includes a transaction system for conducting an exchange for value comprising: a computer terminal comprising a controller for computing a plurality of sets of offer value and offer interval for an object offer, including a first set and a second set, wherein at least one of the offer value and offer interval within a set falls within a distribution envelope that is shaped, at least in part, by a probability distribution function; and wherein at least one of the offer value and offer interval within a set varies from an offer value and an offer interval within a different set by a value having a randomized factor; and a marketing communication link for receiving a first response token and a second response token linked to the first set and the second set.

In still other aspects of the present invention, there is provided a method for conducting a transaction comprising: offering a first object for transacting; computing a first offer value and a first offer interval for making the transaction involving the first object; receiving a response for the first object; offering a second object for transacting; computing a second offer value and a second offer interval for making the transaction involving the second object; facilitating the first set and the second set to be displayed on at least one of a broadcast network and a wide area communication network; receiving a response for the second object; and wherein at least one of the second offer value and the second offer interval differ from the first offer value and the first offer interval by a factor computed by a stochastic process.

In yet other aspects of the present invention, there is provided a trading system employing an adaptive stochastic transaction system in which a first party is disposed to propose an object offer to a second party, which is disposed to accept the object offer. A marketing communication link couples the vendor and the vendee, whereby the vendor and the vendee communicate data relative to an object offer. A distribution channel is incorporated for providing a perceivable indication of the object to be offered so that the vendor may propose the object offer to the vendee through the communication link and wherein the data relative to an object offer includes a quasi-stochastic tuple related to the offer value and wherein the vendee is induced to accept the object offer having the offer value being one of generally equal to and less than the purchase value.

In still yet another aspect of the present invention, there is provided a a transaction system comprising: an event inventory comprising an object total, a computer for establishing a first offer value for each object in a first plurality of objects to be offered during a first offer interval and for establishing a subsequent offer value for each object in a subsequent plurality of objects to be offered during a subsequent offer interval; a marketing communication link for conveying the first plurality of objects at the first offer value over the first offer interval and for conveying the subsequent plurality of objects at the subsequent offer value over the subsequent offer interval to a plurality of vendees; a database for processing a plurality of responses linked to the first plurality of objects and the subsequent plurality of objects; an executable program for adjusting a running number of object total, which is the object total less the first plurality of objects and the subsequent plurality of objects plus a number of canceled objects; and wherein the marketing communication link comprises an Internet link and a telephone network.

Other aspects and variations of the transaction systems summarized above are also contemplated and will be more fully understood when considered with respect to the following disclosure.

### BRIEF DESCRIPTION OF THE DRAWINGS

These and other features and advantages of the present invention will become appreciated as the same become better understood with reference to the specification, claims and appended drawings wherein:

FIG. 1 represents a first exemplary embodiment of adaptive, stochastic transaction system provided in accordance with aspects of the present invention;

FIG. 2 illustrates a business-to-consumer enterprise or transaction system as provided in accordance with aspects of the present invention

FIG. 2A is a pictorial representation of a multimodal, bi-directional communication channel capable of multimedia transmissions for implementing the transaction system in accordance with aspects of the present invention;

FIG. 3 is a graphical representation of a time-domain mapping of a trading event provided in accordance with a first aspect of the present invention;

FIG. 4 is a graphical representation of a time-domain mapping of a trading event provided in accordance with a second aspect of the present invention, which includes at least one stochastic dimension; and

FIG. 5 is yet another mapping of a time-domain mapping of a trading event provided in accordance with another aspect of the present invention, which includes a plurality of stochastic dimension processes.

### DETAILED DESCRIPTION

Embodiments of the present invention encompass an adaptive stochastic transaction system, method, and computer-readable article of manufacture, in which one entity is constituted to communicate a stochastic decision token to at least one second entity, with the intention of inducing the at least one second entity to respond with a desired behavior to the stochastic decision token. The behavior can include the second entity responding to the stochastic decision token with a corresponding response token. A transaction can describe a unit of exchange between the entities and may include a signaling protocol by which the entities indicate their respective transaction intentions. By means of a transaction, the signaling entities exchange a trade object for a trade value. In general, a trade object may be a product, a service, an asset, a resource, an allocation, or an equivalent, as well as a combination thereof. A trade value can be represented by another object, or by an agreed quantity of a defined medium of exchange (DME). In a commercial context, an example of a DME is cash. A transaction may be an actual exchange, or may be a commitment to exchange. In the later case, the actual exchange is initially deferred and later completed by one or more ancillary communications or transfers.

A stochastic decision token includes at least one attribute, property, or value (collectively, dimension) representative of a trade object, which demonstrates stochastic characteristics over a domain, within in a range, or both. In general, a “stochastic” characteristic is one that is non-deterministic, and can be described, at least in pertinent part, by the laws of probability. That is, the dimension characteristics may be generated such that the next state of the dimension tends not to be fully determined by its previous state. For clarity, “stochastic” will be synonymous with “random” encompassing the entire domain of non-deterministic features including, without limitation, pseudo-stochastic and pseudo-random features, as well as quasi-stochastic and quasi-random features. A single non-deterministic variable often is termed a random, or randomized, variable, with an ordered collection, or sequence, of random variables being called stochastic process. A stochastic dimension may be formed of a randomized portion alone, or of a randomized portion in combination with a deterministic portion. Although a future value of a stochastic sequence may not be ascertainable from previous values, a sequence may be devised to reflect a preselected mean and a preselected variance, with values being relatively dispersed within a preselected distribution envelope. Nevertheless, the randomized nature of the dimension can be preserved, even if a deterministic portion of a stochastic variable representing that dimension may be measured, and the corresponding mean value, variance, and distribution function can be ascertained. Within some contexts, metrics corresponding to a desired behavior may be described in terms of risk-talking, efficiency, error, Shannon entropy, and the like.

The first entity may adapt aspects of the system response to the behavior of the second entity, as well as to systemic factors. For example, in response to observed or anticipated behavior by the second entity, the first entity may modify the categories and quantity of trade objects available for exchange, modify access to transactions, manage information pertinent to transactions and trade objects, or shape DME-related, stochastically-derived, trade object attributes by selectively modifying a preselected stochastic process. Therefore, embodiments of transaction systems according to the teachings of the present invention can be configured to be self-adjusting, adaptive transaction systems.

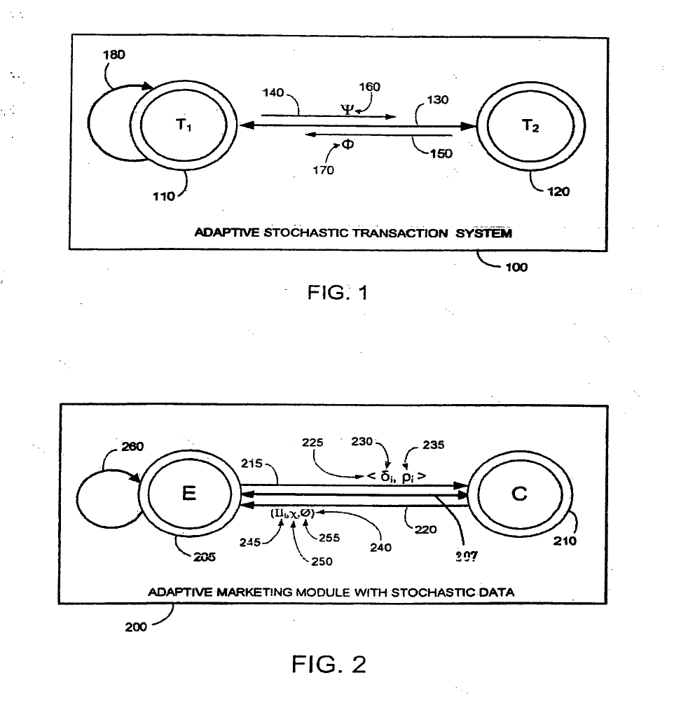

FIG. 1 represents an exemplary embodiment of adaptive, stochastic transaction system 100. Communications proceed by signaling according to a preselected transaction protocol, with respect to a defined transaction. The defined transaction can be a predefined trading event, conducted over a predefined trading interval. In system 100, first transactor T₁ 110 signals at least one stochastic decision token ψ 160, to second transactor T₂ 120; and is connectable with second transactor T₂ 120 through communication route 130, to so communicate. Communication route 130 typically includes uplink 140 and downlink 150. In general, once it is communicated from first transactor T₁ 110 over uplink 140, and perceived by second transactor T₂ 120, stochastic decision token ψ 160 is disposed to induce an observed behavior in second transactor T₂ 120 to solicit a response Φ 170. Stochastic decision token ψ 160 can be representative of a trade value presently associated with the preselected trade object (not shown), which is subject to the present transaction. In view of the stochastic nature of the trade value associated with stochastic decision token ψ 160, future trade values for future offers 180 may be difficult to predict on the basis of past values. This unknown property may be perceived by some as an element of risk. Although difficult prediction of future values, and financial risks, may be undesirable to some persons in certain types of transactions, it can be desirable in the context of the present invention because it is well-known that small risks of many types can be both stimulating and enjoyable for many except, perhaps, for the most risk-averse. Therefore, the stochastic characteristics as employed, for example, in transaction systems according to the present invention, may be affectively stimulating and enjoyable, particularly if the transaction system is embodied within an entertainment milieu.

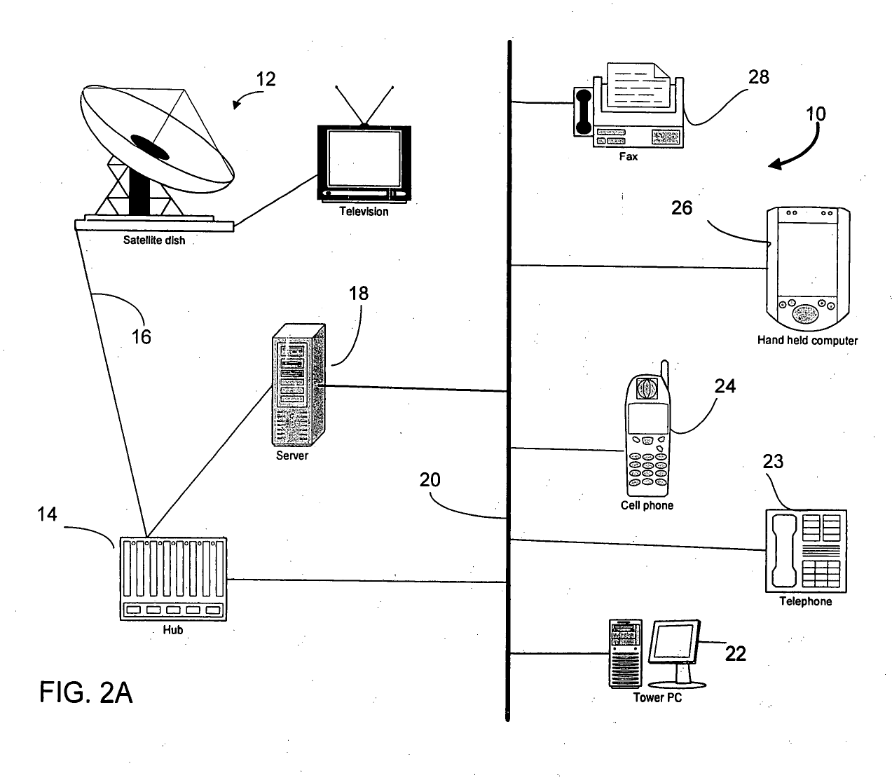

FIG. 2 illustrates business-to-consumer enterprise system 200, which can be similar to adaptive, stochastic transaction system 100, described in FIG. 1. Enterprise system 200 includes enterprise host module 205 (i.e., seller 205), which is coupled to bi-directional communication channel 207, and which thereby can connect to at least one consumer module 210 (i.e., buyer 210). When connected through channel 207, seller 205 and buyer 210 may engage in a transaction for one or more preselected trade objects using a preselected trade protocol. Channel 207 can include at least uplink 215 and downlink 220, and it may be desirable that one or more selected links in communication route 207 be a multimodal, bi-directional communication channel, capable of multimedia transmissions and, further, of one or more of asynchronous, isochronous, broadcast, or multicast, communications, using wired and wireless signal communication techniques. Further, communication route 207 can provide one or more communication links that traverse a point-to-point communication network, a circuit-switched communication network, a store-and forward communication network, a packet-switched communication network, a broadcast communication network, and a combination thereof. An exemplary communication network presently having store-and-forward and packet-switched features, with quality-of-service-aware capabilities (e.g., isochronous, asynchronous, etc.), may include a packet-switched communications internetwork, such as the Internet. Another type of communication network, the public switched telephone network, is an example of a circuit-switched network facilitating point-to-point communications. Likewise, an interactive producer-to-consumer satellite-based broadcast network may exemplify an exemplary broadcast communication network, which also include a cable-access (CATV) link. Furthermore, present wireless mobile communication devices enable hand-held multimedia communication with text messaging, video, audio, and stored program features. Thus, although communication route 207 may employ a single mode and class of communication network, or link, it is within the scope of the present invention that communication between parties may be accomplished using multiple modes, links, and classes of communications entities. For example, the communication path and nature of components constituting uplink 215 may be distinct from those constituting downlink 220. Indeed, in selected embodiments of the present invention, at least a portion of uplink 215 may include a broadcast network, by which a video presentation of a transaction is televised from seller 205 to buyer 210. In addition, at least a portion of downlink 220 may include a computer internetwork, such as the Internet, or a public telephone network, by which buyer 210 may respond to a televised presentation by seller 205.

FIG. 2A is a pictorial representation of a multimodal, bi-directional communication channel capable of multimedia transmissions, generally represented as 10. In one exemplary embodiment, an uplink 215 for communicating a stochastic decision token by a first party or seller to one or more buyers or second parties comprises a broadcast network 12 by which a video presentation of a transaction is televised. Input to the broadcast network 12 may be from a seller's hub 14 by way of an optical transfer medium 16, such as an optic cable. The seller may also broadcast or provide an uplink 215 using a packet-switched communications internetwork using a server 18 connected to the Internet 20 and/or a public switched network facilitating point-to-point communication with its hub 14. A buyer may communicate a return response using a personal computer 22, a land telephone 23, a cell phone 24, a handheld computer 26, or a fax machine 28 to commit to a transaction (or to cancel a prior committed order as further discussed below).

The adaptive stochastic transaction system discussed elsewhere herein may be implemented on the server 18 and include a database for linking stochastic decision tuples with corresponding response tokens. Existing prior art registration systems may be incorporated to authenticate vendees or buyers and for registering the same.

While in FIG. 1, first transactor T₁ 110 signals at least one stochastic decision token ψ 160, to second transactor T₂ 120, in FIG. 2, seller 205 is disposed to signal at least one stochastic decision tuple 225 to buyer 210 through downlink 215. As before, seller 205 signals buyer 210 with a query described by stochastic decision tuple 225, with the intention of inducing buyer 210 to respond to stochastic tuple 225 with a desired behavior. In general, once perceived by buyer 210, stochastic decision tuple 225 is disposed to induce an observed behavior in buyer 210, including a response to seller 205. Desirably, stochastic decision tuple 225 is an ordered set of one or more dimensions associated with an intended transaction between seller 205 and buyer 210. At least a portion of one dimension is generated by seller 205 as a stochastic portion, as indicated previously. Stochastic decision tuple 225 may be, for example, a singleton or a duplet, which are sets having one element and two elements, respectively. An exemplary singleton may contain a element or dimension, which is stochastic in part or in whole. For example, offer value ρ 235, can be generated from a base value, which is summed with a randomized value, and can be representative of a trade value associated with the preselected trade object (not shown) presently being transacted. An exemplary duplet may contain two dimensions, for example, offer value ρ 235 and offer interval δ 230, at least one of which being stochastic in part, or in total. Tuple 225 also may include three or more values, at least one of which also being stochastic in nature. Although tuple 225 may contain multiple dimensions of information, it nevertheless can be adapted to form a compact token, as may be desirable to minimize the resources used to facilitate one-to-many transmission, such as transmission time and power, channel capacity, bandwidth, and so on. Thus, whether seller 205 is connected simultaneously through channel 207 to one buyer 210, or to one hundred thousand buyers 210, it may be sufficient to simultaneously query buyer(s) 210 with one stochastic decision tuple 225.

For clarity, stochastic decision tuple 225 is described in terms of a stochastic two-element set <δ,ρ>. Set element δ 230 can be representative of an offer interval, or the time over which a corresponding offer value may be considered valid. That is, upon expiration of offer interval δ 230, paired offer value ρ 235 is revoked. Similarly, set element ρ 235 can be representative of an offer value, or present stated cost for a trade object. Also, where offer tuple 225 is one of an ordered sequence of stochastic tuples signaled over time to buyer 210, interval δ 230 and offer value ρ 235 can be indexed to their respective order in the associated time sequence, such that tuple 225 can be symbolized by <δᵢ, ρᵢ>. One or both of offer interval δᵢ 230 and offer value ρᵢ 235 can be stochastic. However, when only one element of a duplet 225 is stochastic, it is desirable that offer value ρᵢ 235 be randomized.

In certain embodiments, the preselected trade protocol describes a trading event during which a preselected trade object may be offered to buyer 210. The span of a trading event can be subject to one or more limitations, such as a predefined trading interval Δ, a preselected trade object count and so forth. A predefined trade object count can be a trading event inventory (i.e., the maximum number of trade objects allocated for a given trading event), or a total trade object inventory (i.e., the maximum number of trade objects available for allocation). Typically, the span of a trading event Δ_{N} can be described in terms of the time represented by the maximum number N of predefined offer intervals allocated to the trading event. For example, if the maximum span of trading interval Δ encompasses N offer intervals δᵢ 230, then trading interval Δ_{N} may be described as the sum of N offer intervals δᵢ 230. Symbolically:

$$Δ = {\sum }_{i = 1}^{N} {δ}_{i}$$

Ordinarily, seller 205 signals stochastic tuple <δᵢ,ρᵢ> 225 to buyer 210 prior to the an i^{th} offer interval, for example, during the (i−1)^{th} offer interval, thereby indicating that the i^{th} offer interval will have a duration of δᵢ, during which the preselected trade object will be offered at a offer value of ρᵢ. When ρᵢ is generated as a stochastic variable, the offer values ρ₁, ρ₂, ρ_{N} can be perceived by buyer 210 as varying randomly, even if within a predefined range of values. Moreover, offer values ρ₁, ρ₂, ρ_{N} also may appear to be generally random and uncorrelated to an unscrupulous observer attempting to manipulate future offer values of a trading event on the basis of past values or to otherwise use process, participant, or trade object information to subvert the commercial process evolving between seller 205 and buyer 210. Such disreputable practices can be especially burdensome for some types of transactions.

For example, in highly-structured negotiations, such as auctions, process subversion, shilling, price and value manipulation, and other fraudulent, collusive, predatory, or entry-deterring behavior can substantially reduce the efficiency, fairness, and simplicity of the negotiations, particularly for recurring or parallel negotiations. A venue in which such undesirable activities were perceived to hold sway, is likely to experience reduced profitability and loss of target clientele. Perhaps more significantly, transactions which may be perceived as based on a potentially corruptible and unfair process, or as suitable only for those with special knowledge or skills, may discourage a substantial population of potential participants from engaging in those transactions. Unfortunately, marketgoers who are vexed and dissatisfied with explicit and implicit collusion, shilling, process manipulation, and the like, in online auctions, bazaars, swap sites, and other popular marketplaces may rarely, if ever, return. Additionally, costly measures such as conduct policing systems and reputational screening may be needed to preserve an acceptable degree of integrity in the operation.

Nevertheless, motivated observers may seek for unfair advantage, relevant information regarding a transaction, or class of transactions, as well as the corresponding transactional process. Skilled analysis of past process performance, as well as of the signals used during negotiations, also may permit the analyst to expressly or implicitly distort the transaction process and outcomes to an unfair advantage. Despite certain safeguards, unscrupulous conduct may be encouraged, before or during a transaction, by the open availability of information characterizing the trade object to be transacted; the trade object pricing, value, and authenticity; the transaction participants, and their likely behavior; the economic environment of the transaction, including financial state of the seller, broker, or both; as well as other uncovered private information relevant to the transaction. This information then may be used to unfairly extract significant profits for the dishonest actor.

Thus, the use of stochastic decision tuple 225 can be a desirable transactional signaling device, because an observer of a stochastic process may not be able to predict, with a reasonable degree of certainty, a future value of a randomized element from a previous value, even if general characteristics of the process are known or can be determined. As a result, stochastic transaction signaling according to the embodiments herein, provides an elegant, effective barrier to process subversion, collusion, and similar undesirable influences, because of the onus of extracting timely, useful information from the stochastic transaction signals, which seller 205 communicates to buyer 210, is of little or no value.

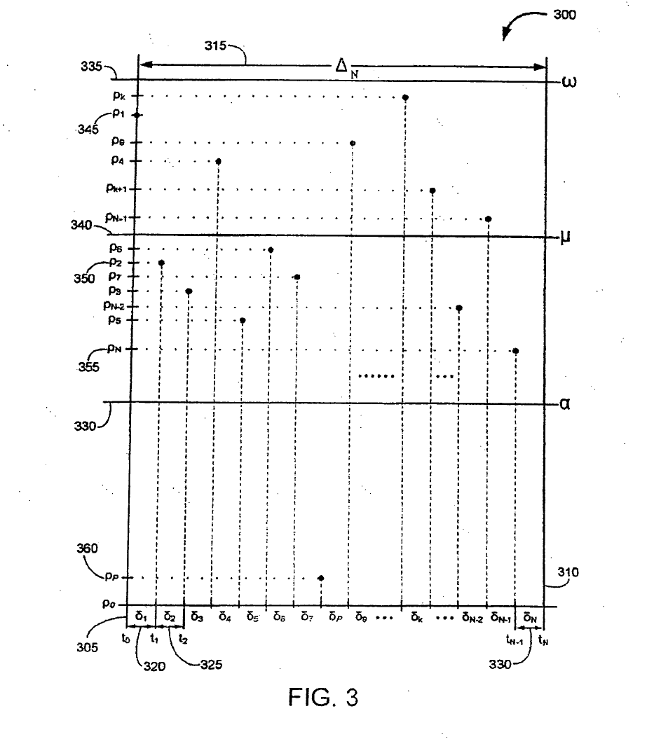

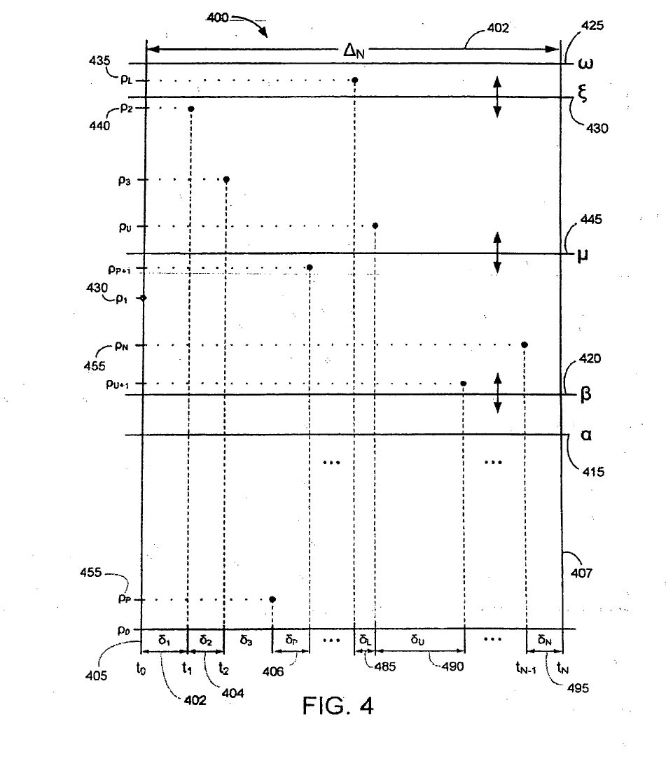

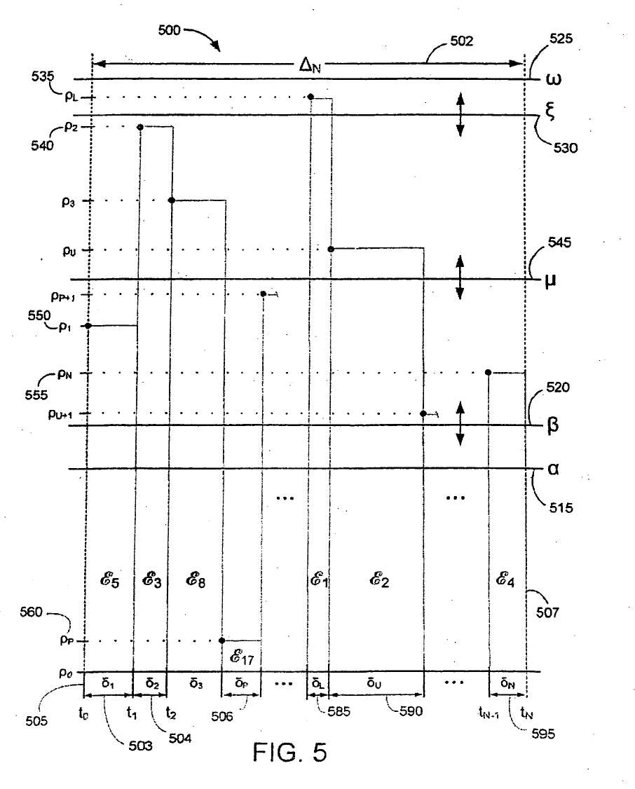

Generally, one aspect of the preselected trading protocol involves seller 205 signalling buyer 210 with stochastic decision tuple <δᵢ,ρᵢ> 225 prior to the beginning of the i^{th} period of trading interval Δ_{N}. Dimension δᵢ 230 represents the duration of i^{th} period of trading interval Δ_{N}. Dimension ρᵢ 235 represents the offer value to be asserted during the i^{th} offer interval. Thus, stochastic decision tuple <δᵢ,ρᵢ> 225 is representative both of a time dimension and a cost/price dimension, and is a signal to buyer 210 from seller 205 that, starting from the beginning of the i^{th} period and lasting only for an interval of δᵢ 230, buyer 210 may take the trade object of the transaction at a value of ρᵢ 235. However, after offer interval δᵢ 230 elapses, the offer value of ρᵢ 235 is revoked and invalid. Should buyer 210 wish to take the trade object, the next opportunity to do so will occur during the (i+1)^{th} period of trading interval Δ_{N}, with subsequent stochastic decision tuple <δᵢ₊₁,ρᵢ₊₁> 225 describing subsequent offer value ρᵢ₊₁ 235 and the subsequent offer interval δᵢ₊₁ 230 during which offer value ρᵢ₊₁ 235 will be considered to be valid. In general, if ρ is a stochastic dimension, then the magnitude of offer value ρᵢ₊₁ may be greater than, less than, or equal to, the magnitude of offer value ρᵢ, ρᵢ₊₂, or any other offer value in the sequence of offer values presented to buyer 210 during the subject trading event. A graphical representation of a time-domain mapping of a trading event will be illustrated in FIG. 3, in which seller 205 signals buyer 210 with tuple 225 bearing stochastic offer value ρ 235 and deterministic offer interval δ 230. Graphical representations of trading events in which seller 205 signals buyer 210 with tuple 225 bearing both stochastic offer interval δ 230 and stochastic offer value ρ 235 will be illustrated in FIG. 4 and FIG. 5.

Relative to one embodiment of a preselected trading protocol employed in system 200, buyer 210 may initiate communication with seller 205 through uplink 220 of channel 207, expressing an intention to engage in a mutually beneficial exchange, or a trade. Seller 205 then can signal stochastic decision tuple <δᵢ,ρᵢ> 225 to buyer 210 for evaluation and response. After perceiving the information received from seller 205 in stochastic decision tuple <δᵢ,ρᵢ> 225, buyer 210 can signal seller 205 with response token 240. Typically, buyer can assign preselected response values to response token 240, as described under the preselected trading protocol. For example, response token 240 can be assigned a response value of COMMIT Πᵢ 245, or CANCEL χ 250. Desirably, COMMIT response Πᵢ 245 can be linked, for example, using index i, to corresponding offer interval δᵢ 230 and corresponding stochastic offer value ρᵢ 235, to verify that buyer 210 is responding to the present values, which also can be linked, for example, using index i. Conveniently, NULL response Ø 255 can cause a default value of REJECT to be assigned to token 240. Thus, by not responding within a period described by the preselected trading protocol (typically, the offer interval δᵢ), seller 205 may assume that buyer 205 declined, or rejected, the offer to trade during the i^{th} offer interval δᵢ, at the i^{th} offer value ρᵢ. Desirably, the preselected trading protocol instructs buyer 210 to make an affirmative act, in order to signal seller 205. For example, with a COMMIT Πᵢ response 245 being assigned to token 240, buyer 210 makes a commitment to seller 205, during offer interval δᵢ, to exchange for the preselected trade object, an in the amount of DME equivalent to offer value ρᵢ, by which commitment a transaction is made. Also, seller 205 may permit buyer 210 to issue a CANCEL χ response 250, by which a made transaction subsequently is repudiated. In this particular embodiment, both COMMIT Πᵢ or CANCEL χ responses are accomplished by affirmative steps of buyer 210, which can lessen the likelihood of spurious transactions. Unless buyer 210 disconnects from uplink 220, the trade object inventory is exhausted, or trade interval Δ_{N} has elapsed, seller 205 can be disposed to signal another stochastic decision tuple <δᵢ₊₁,ρᵢ₊₁> 225, shown as a repeat offer 260 based on a different stochastic decision tuple, to buyer 210.

To seller 205, the preselected trading protocol includes signaling buyer 210 with stochastic decision tuple <δᵢ,ρᵢ> 225, awaiting for a predefined decision period, e.g., offer interval δᵢ, the receipt of response token 240 from buyer 210. Thus, a simple model of transaction communication in system 200 is one of query between seller 205 and buyer 210 over downlink 215, and response between buyer 210 and seller 205 over uplink 220. In this model, a query may be in the form of tuple 225 and a response may be in the form of token 240.

If, during offer interval δᵢ, buyer 210 signals seller 205 with token 240 bearing COMMIT value 245, then seller 205 makes the transaction with buyer 210. If, after making the transaction, buyer 210 signals with token 240 bearing a CANCEL value χ, then seller 205 cancels the transaction with buyer 210. Unless the trading event has ended, seller 205 can repeat the query by signaling buyer 210 with next stochastic decision tuple <δᵢ₊₁,ρᵢ₊₁> 225. Alternately, to avoid the costs of canceling a made transaction, seller 205 may defer finalization of transactions (making and canceling) until the close of the trading event. However, from the perspective of the buyer, issuing a COMMIT response token 240 to seller 205 may be regarded as a non-contingent transaction, cancelable at the discretion of seller 205, and not as a matter of protocol, as with other classes of transactions, such as auctions or speculation buys. It may be beneficial to seller 205 to permit buyer 210 to freely cancel a transaction, however, due to the higher costs related to returned orders, refunds, credit card transaction corrections, restocking, and so on.

From the perspective of buyer 210, one embodiment of a preselected trade protocol can include connecting with seller 205 via uplink 220 and request access to a predefined trading event for a preselected trade object. Accessing seller's transaction system should include a registration process, such as providing a name, a mailing address, requesting a user ID and password, and registering a payment option (e.g., credit card information). If buyer has previously registered, an IP address or a telephone ID may be used to link buyer with a registered purchaser. If access is granted, buyer 210 is queried by stochastic decision tuple <δᵢ,ρᵢ> 225 from seller 205. By perceiving the information in stochastic decision tuple <δᵢ,ρᵢ> 225, buyer 210 understands that the preselected trade object can be obtained at offer value ρᵢ, with the offer being valid only for the remaining duration of offer interval δᵢ. If buyer 210 elects not to make the transaction under those terms, perhaps with the hope that a future offer value, such as offer value ρᵢ₊₁ will be less than offer value ρᵢ, perhaps significantly less, then buyer 205 will allow offer interval δᵢ to elapse without action. Of course, due to the stochastic nature of at least one dimension (here, ρᵢ) of tuple 225, the magnitude of future offer value ρᵢ₊₁ may be greater than, equal to, or less than, the magnitude of current offer value ρᵢ. By not responding to seller 205 within offer interval δᵢ, buyer 210 has constructively rejected the offer from seller 205 to make a trade for the preselected trade object at offer value ρᵢ. Upon, or shortly before, the expiration of offer interval δᵢ, but before the end of trading interval Δ_{N}, buyer 210 can be queried again by receiving stochastic decision tuple <δᵢ₊₁,ρᵢ₊₁> 225 for evaluation and response.

Should buyer 210 elect to make a trade for the trade object subject to the trading event at offer value ρᵢ₊₁, it is desirable that buyer 210 assign a value of COMMIT Πᵢ₊₁ 245 to token 240 and respond with token 240 so that it is received by seller 205, before the expiration of offer interval δᵢ₊₁. Upon receipt of the COMMIT Πᵢ₊₁ 245 response from buyer 210, seller 205 can proceed to make the requested transaction, using offer value of ρᵢ₊₁ 235 as the trading price. Should buyer 210 hesitate in taking the present offer of seller 205, and seller 205 does not receive token 240, bearing the COMMIT response Πᵢ₊₁ 245, before offer interval δᵢ₊₁ elapses, the effect can be that of NULL Ø response 255, i.e., a default REJECT response. If buyer 210, after making a trade with seller 205 during offer interval δᵢ₊₁, decides that continuing with the transaction is undesirable, buyer 210 may signal with response token 240 bearing a CANCEL value χ.

FIG. 3 is a mapping representative of possible outcomes of stochastic dimension process (generally at 300), which may be used to generate stochastic decision tuple sequence <δ, ρ>. For clarity, the mapping of process 300 is two-dimensional, within the time domain (x-axis) and a “price” range (y-axis). That is, each element of a sequence corresponds to a two-dimensional characteristic, respectively, a position in time and an assigned value of a defined medium of exchange, typically a monetary value. Accordingly, the x-axis of the mapping depicts trading interval Δ_{N} 315 for a defined trading event. Trading interval Δ_{N} 315 is described by offer interval sequence δ, specifically by constituent offer intervals δ₁, δ₂, δ_{N}. Similarly, the y-axis of the process mapping depicts the range of offer value sequence ρ, including constituent offer values ρ₁, ρ₂, ρ_{N}. Each randomized offer value ρᵢ respectively and uniquely corresponds to an offer interval δᵢ having the same i^{th} index value (where i=1 to N).

Trading interval Δ_{N} 315 begins at t₀ 305 and may run until t_{N} 310 such that the maximum time allocated for trading interval Δ_{N} 315 is symbolized by:
Δ_{N}=t_{N}−t₀

As discussed with respect to FIG. 1, above, the maximum time allocated for trading interval Δ_{N} 315 also may be expressed as the sum of the constituent offer intervals δ₁, δ₂, δ_{N}. That is:

$${Δ}_{N} = {\sum }_{i = 1}^{N} {δ}_{i}$$

Trading interval Δ_{N} makes reference to a “maximum” time although, in practice, a predefined trading event may terminate before this maximum time span is reached. A trading event also may be extended, at the discretion of the seller. With the predefined trading event beginning at t₀ 305, the first offer interval δ₁ 320 is defined to span interval t₀ to t₁, second offer interval δ₂ 325 is defined to span interval t₁ to t₂, and so on, up to N^{th} offer interval δ_{N} 330, which is defined to span interval t_{N-1} to t_{N}. In FIG. 3, offer intervals δᵢ are illustrated to be deterministic in time domain. In this example, offer intervals δᵢ generally are of the same duration. As will be seen with respect to FIG.4 and FIG. 5, the duration of offer intervals δᵢ also may be stochastic. Therefore, both deterministic and non-deterministic domain values, e.g., offer intervals δᵢ, are within the scope of the present invention.

Turning now to the description of range dimension ρ, a sequence of stochastic offer values ρᵢ can be generated by a preselected non-deterministic process, such as one of many, well-known pseudo-random number generators (PRNG), so that the sequence generally does not exhibit a determinable pattern over time. Advantageously, offer values ρᵢ may be defined to vary between a preselected floor value [α] 330 and a preselected ceiling value [ω] 335. Furthermore, offer value ρᵢ can be generated to lie within a preselected distribution envelope, with a mean value μ 340. In the context of FIG. 2, seller 205 may generate the <δ,ρ> dimensions of stochastic decision tuple 225, using preselected non-deterministic process 300, either prior to, or during (“on-the-fly”), a trading event. In certain embodiments, preselected floor value [α] 330 can correspond to the lowest offer values ρᵢ that a seller is willing to accept for a particular trade object, during a particular trading event. For example, preselected floor value [α] 330 may reflect a seller's cost-to-market price for the preselected trade object subject to the trading event. Similarly, preselected ceiling value [ω] 335 can correspond to the highest offer value ρᵢ that a buyer may be willing to pay for a particular trade object, during a particular trading event. Again, by example, preselected ceiling value [ω] 335 may reflect an identified maximum market value (e.g., manufacturer's suggested retail price) for the preselected trade object subject to the trading event. In addition, mean value μ 340 can correspond to the target price that seller 205 assigns to the preselected trade object. This target price may reflect an acceptable gain or margin that the seller may expect to extract, on average, from the buyers as a result of trading event transactions. Although preselected ceiling value [c)] 335, preselected floor value [α] 330, and mean value μ 340 may generally characterize the expected outcomes from process 300, it may be beneficial to shape, or weight, the distribution of offer values ρᵢ, such that the variance of offer values ρᵢ may increase, decrease, or be shifted to a range closer to preselected ceiling value [ω] 335, or preselected floor value [α] 330. As a result, the initial mean value μ 340 expectation may be varied, as well, for example, to reflect market conditions and to modify a present buyer response.

Process 300 generates a particular offer value ρ for a corresponding interval δ. Broadly stated, two significant components of stochastic process generation include a pseudo-random number generation (PRNG) technique and the selected probability distribution function P(x). In general, the PRNG device or technique generates randomized values corresponding to a dimension; the selected probability distribution function P(x) can be used to shape the distribution envelope of the PRNG output. The dimension can be randomized PRNG outcomes that are assigned as offer values ρ. A distribution envelope corresponding to P(x) describes general bounds of the sample space within which a sequence of offer values ρ are generated, as well as the spatial position within the dimension, or value assigned to one sample relative to another. It is desirable to use a PRNG device or technique that does not exhibit an undesired value bias; does not demonstrate a unique, short-term “signature” sequence; or is not susceptible to identification through prolonged observations. These are well known in the sciences, engineering, and applied mathematics arts, and will not be elaborated. By carefully selecting a probability distribution function P(x) to cooperate with a PRNG, the randomized values produced can be substantially within a definable subspace of possible PRNG outcomes. Moreover, the definable subspace of P(x) outcomes can be shaped so that the values resulting from the outcomes can be generally distributed within a preselected distribution envelope. For example, preselected stochastic process 300 may generate random portions of a dimension according to a normal, or Gaussian, probability distribution, which tends to produce random portions in a range described by the familiar “bell curve”-shaped distribution envelope, relative to a preselected mean value μ 340. Where preselected stochastic process 300 employs a uniform probability distribution to produce a randomized portion of a dimension, the random portion tends to be distributed within a rectilinear, e.g., generally square or rectangular, distribution envelope, relative to the preselected mean value μ 340. Similarly, preselected stochastic process 300 can be selectively adapted with a myriad of other probability distributions, well-known by ordinary practitioners. These distributions can be weighted, skewed, multimodal, or composites of other probability distributions. Non-limiting examples of probability distributions that may be used include, alone or in combination, Cauchy, Cosine, Double Gamma, Laplace, and Student's-t distributions, as well as Beta, Burr, Chi, Fisk, Log Normal, and Triangular distributions. A distribution envelope may be approximated by preselected ceiling value [ω] 335 and preselected floor value [α] 330, respectively. However, it may be advantageous to approximate upper and lower boundary regions by range values that may be approximated by functions other than by preselected ceiling value [ω] 335 and preselected floor value [α] 330, respectively. In addition to receiving the above treatment, an offer value ρ, or sequence of offer values ρᵢ, may be scaled, normalized, or be otherwise dimensionally adapted to the desired range of offer values ρᵢ.

Returning to FIG. 3, first stochastic decision tuple <δ₁,ρ₁> is an initial transaction query that signals the beginning of trade interval Δ_{N} 315 at t₀ 305. First stochastic decision tuple <δ₁,ρ₁> generally indicates that, for the duration of first offer interval δ₁ 320, i.e., from t₀ to t₁, a preselected trade object made be traded (e.g., purchased) for the amount described by first trade value ρ₁ 345. However, the offer at first value ρ₁ 345 is time-limited—unless the buyer signals a commitment to trade at trade value ρ₁ 345 before the expiration of trading interval δ₁ 320, the offer will be revoked at t₁. At t₁, the dimensions associated with second stochastic decision tuple <δ₂,ρ₂> are in force. That is, for the duration of second offer interval δ₂, i.e., from t₁ to t₂, the preselected trade object made be traded for the amount described by second trade value ρ₂ 350. As with first trade value ρ₁ 345, the offer to trade at second offer value ρ₂ 350 is limited to the duration of second offer interval δ₂. Provided the trading event remains unterminated, an unanswered seller query with stochastic decision tuple <δₖ,ρₖ> evokes a subsequent query with stochastic decision tuple <δₖ₊₁,ρₖ₊₁>, with repeated querying continuing until the values of the last stochastic decision tuple <δ_{N},ρ_{N}> become effective at t_{N-1}. The duration of final offer interval δ_{N} 330 begins at about t_{N-1} and continues until t_{N} 310, at which time, event interval Δ_{N} 315 expires, typically bringing the corresponding trading event to an end. During final offer interval δ_{N} 330, final offer value ρ_{N} 355 is considered to be valid. Upon completion of the N^{th} interval of event interval Δ_{N} 315, final offer value ρ_{N} 355 also is revoked, and uncancelled, committed transactions can be cleared. If necessary, logistics and financial arrangements can be made for finalizing the transaction at the agreed offer value ρₖ and for transferring the selected trade object to the buyer.

Selected embodiments also provide seller 205 with the ability to interject promotional offer value ρₚ for the duration of a selected offer interval, here, offer interval δ₈. As with other offer values, it may be advantageous to prepare promotional token <δₖ,ρₚ> in advance of the k^{th} period in which it will be used, for example, prior to the trading event commences (i.e., before t₀), or on-the-fly, during the trading event. Promotional offer value ρₚ may be a desirable inducement for potential new buyers to join the selected trading event, or for participating buyers to gain a heightened sense of excitement and entertainment while awaiting from seller 205, a potential transaction query having promotional token <δₖ,ρₚ>. Promotional token <δₖ,ρₚ> may be provided with a shorter offer interval δₖ than is provided otherwise. Typically, desirable response behaviors, which are induced in buyer 210 by promotional token <δₖ,ρₚ> may include intended desirable perturbations, including surprise and excitement; more pragmatically, induced behaviors further may include motivating buyer 210 to commit to the transaction proposed by ρₚ, as well as a sense of urgency, for example, to decide whether to COMMIT to the promotional offer, and to do so before promotional offer interval δₖ expires. In a commercial implementation, promotional offer value ρₚ may be, for example, an offer value substantially below seller cost; a premium or promotional benefit such as free merchandise, services, and the like; and a combination thereof. In other implementations, promotional offer value ρₚ may represent a limited opportunity to obtain enhanced priority, services, or both; as well as a large perturbation, intended to motivate the perturbed party to respond in an intended manner, desired by the party signaling the perturbation.

FIG. 4 also is a mapping representative of possible outcomes of stochastic dimension process (generally at 400), which may be used to generate stochastic decision tuple sequence <δ,ρ>. For clarity, the mapping of process 400 is two-dimensional, within the time domain (x-axis) and a “price” range (y-axis). That is, each element of a sequence corresponds to a two-dimensional characteristic, respectively, a position in time and an assigned value of a defined medium of exchange, typically a monetary value. Accordingly, the x-axis of the mapping depicts trading interval Δ_{N} 402 for a defined trading event. Trading interval Δ_{N} 402 is described by offer interval sequence δ, specifically by constituent offer intervals δ₁, δ₂, . . . , δ_{N}. Similarly, the y-axis of the process mapping depicts the range of offer value sequence ρ, including constituent offer values, ρ₁, ρ₂, . . . , ρ_{N}. Similar to FIG. 3, offer values ρᵢ can vary randomly in nature. By carefully selecting a probability distribution function P(x) to shape the randomized range of values output by a PRNG, a definable subspace of possible RPNG outcomes generally may be approximated by a preselected distribution envelope described by probability distribution function P(x).

Unlike FIG. 3, in which offer intervals δᵢ are depicted as having a generally uniform duration, offer intervals δᵢ of FIG. 4, are stochastic in nature. That is, the duration of selected offer intervals δᵢ may vary substantially randomly. Conveniently, probability distribution function P(x) may be used to generate both offer values ρᵢ and offer intervals δᵢ. However, the domain of values over which offer intervals δᵢ run may be generated instead by probability distribution function Q(x), where (P(x)≠Q(x)). Desirably, each randomized offer value ρᵢ can respectively, and may uniquely, correspond to an offer interval δᵢ having the same i^{th} index value (where i=1 to N).

A trading event, within the context of process 400, may transpire over trading interval Δ_{N} 402, which may run from t₀ 405 to t_{N} 407. First offer interval δ₁ 403 may run between t₀ 405 and t₁, corresponding to first offer value ρ₁ 430. Second offer interval δ₂ 404 may run between t₁ and t₂, corresponding to second offer value ρ₂ 440. Offer intervals may be further divided logically, such that final offer period δ_{N} 495, may run between about t_{N-1} and t_{N} 407, and may correspond to final offer value ρ_{N} 455. A trading event also may be terminated before the entire trading interval 402 elapses, or may be extended, for example, at the discretion of seller 205. Because of their stochastic nature, selected ones of offer intervals δ₁, δ₂, . . . , δ_{N} may have durations longer than, shorter than, or of approximately the same duration as, selected other offer intervals δ₁, δ₂, . . . , Δ_{N}. The selected duration of an offer interval δᵢ, can be generated by probability distribution function Q(x) to vary generally between predetermined minimum offer interval δ_{L} 485 and predetermined maximum offer interval δ_{U} 490. Probability distribution function Q(x) can be selected such that the corresponding distribution envelope of the offer interval δᵢ substantially conforms to the sample subspace desired.

Similar to stochastic process 300 in FIG. 3, two-dimensional non-deterministic process 400 in FIG. 4 can implement one or more well-known PRNG devices and techniques (PRNG), in one or more dimensions, to generate sequences of stochastic offer values ρᵢ and stochastic offer intervals δᵢ. Corresponding respective probability distribution functions, P(x) and Q(x), may be preselected to cooperate with the PRNG so that the randomized values produced thereby can be substantially within a definable subspace of possible PRNG outcomes. Also, preselected stochastic process 400 can be chosen from among one or more of a wide array of weighted, skewed, multimodal, or composite, probability distributions, with each distribution typically being dispersed around a preselected mean value. In FIG. 3, stochastic offer values ρᵢ may vary between a preselected floor value [α] 330 and a preselected ceiling value [ω] 335, within a preselected distribution envelope dispersed about mean value μ 340. Likewise, the stochastic offer values ρᵢ in FIG. 4 may vary between a preselected floor value [α] 415 and a preselected ceiling value [ω] 425, within a preselected distribution envelope dispersed about mean offer value μ 445. Offer intervals δᵢ may vary between predetermined minimum offer interval δ_{L} 485 and predetermined maximum offer interval δ_{U} 490, within a preselected distribution envelope, which may be distributed about some mean interval value (not shown). Non-limiting examples of probability distributions that may be used include, alone or in combination, Uniform, Gaussian, Cauchy, cosine, Double Gamma, Laplace, and Student's-t distributions, as well as Beta, Burr, Chi, Fisk, Log Normal, and Triangular continuous distributions, as well the gamut of suitably chosen discrete distributions.

Unlike process 300 in FIG. 3, embodiments according to process 400 in FIG. 4 may possess an adapted mean value value μ 445, which may result from implementation of adapted upper target offer value ξ 430 and adapted lower target offer value β 420. It may be desirable to adapt one or both of value ξ 430 and value β 420 in response to factors of the environment in which the trading event occurs. Where transactions described herein are within a commercial context, environment factors can include trade object supply side environment factors (e.g., availability of trade objects from a supplier), trade object demand side environment factors (e.g., demand trends among consumers), as well as other environment factors including, without limitation, fluctuations in overhead expenses; changes in finance, energy and transport costs; geopolitical factors; and so on). The adapted trade range between upper value ξ 430 and lower value β 420 also may be indicative of a range of offer values ρᵢ, which has been determined, such as by seller 205 in FIG. 2, to be representative of a range in which buyer 210 is more likely to COMMIT to a transaction. In general, an increase in one or a paired increase in both of adapted lower target offer value β 420 and adapted upper target offer value ξ 430, may result in an increase in mean value μ 445. Should preselected floor value [α] 415 generally correspond to, for example, the cost-to-market to seller 205 for a trade object, the effect of raising selected lower target offer value β 420 can be to increase the margin of seller 205. By contrast, a decrease in one or a paired decrease by both of adapted lower target offer value β 420 and adapted upper target offer value ξ 430, may result in a decrease in adapted mean value μ 445. This reflects a tendency for a transaction to bring a lower offer value ρᵢ for a given trade object. Should preselected floor value [α] 415 be representative of the cost-to-market to seller 205 for a trade object, the aforementioned tendency to decrease adapted mean value μ 445 generally reflects a tendency for buyer 210 to make a transaction for a trade object at a savings and a tendency for seller 205 to yield a lower margin from the transaction. Of course, a trend towards a lower price for a trade object, typically results in a trend for additional transactions for the object, which may be desirable for seller 205. Advantageously, adapted lower target offer value β 420 and adapted upper target offer value ξ 430 can cooperate such that stochastic offer values ρᵢ may vary between adapted lower target offer value β 420 and adapted upper target offer value ξ 430, within a preselected distribution envelope dispersed about adapted mean value μ 445. Importantly, adapted lower target offer value β 420 and adapted upper target offer value ξ 430 may be so adapted before, during, or after a trading event. For an example during a trading event, if seller 205 notices a reluctance to transact on the part of buyer 210, seller 205 may reduce one or both of adapted lower target offer value β 420 and adapted upper target offer value ξ 430 to result in a decreasing trend in adapted mean value μ 445. Thus, although buyer 210 may still perceive one or both of offer intervals δᵢ and offer values ρᵢ as being generally stochastic, the distribution envelope characterizing offer values ρᵢ may be perceived as tending lower, thereby tending to induce buyer 210 to COMMIT to make a transaction. Not only may adapted lower target offer value β 420 and adapted upper target offer value ξ 430 be adapted dynamically (on-the-fly), for example, to shift adapted mean value μ 445 higher or lower, the distribution envelope corresponding to the values produced for process 400 also may be adapted. For example, it may be desirable to reduce (or increase) adapted mean value μ 445, as well as to adapt distribution function P(x) such that offer values ρᵢ are generated within an exemplary Gaussian distribution envelope instead of an exemplary Uniform distribution. Therefore, embodiments of the present invention provide methods and apparatus offering flexibility in generation of the stochastic characteristics of a trade object, as perceived by an engaged transactor. Flexibility in the dimension of offer values ρᵢ can be complemented by flexibility in the dimension of offer intervals δᵢ. That is, embodiments of the present invention provide methods and apparatus offering flexibility in generation of the stochastic characteristics of a trade event, as perceived by an engaged transactor. For example, it may be desirable to reduce (or increase) a mean value for offer interval δᵢ, as well as to adapt distribution function Q(x) such that offer intervals δᵢ are generated within an exemplary Gaussian distribution envelope instead of an exemplary Uniform distribution. Distribution function Q(x) may be adapted further such that offer intervals δᵢ can at least weakly correspond to offer values ρᵢ. For example, it may be desirable to generate a distribution envelope for offer intervals δᵢ such that offer intervals δᵢ tend to be shorter when offer values ρᵢ approach the extreme of the distribution envelope representative of distribution function P(x), and that offer intervals δᵢ are generally longer for offer values ρᵢ tending toward the mean value μ 445, representative of function P(x). However, another result, and another correspondence, between offer intervals δᵢ and offer values ρᵢ may be desired. Nevertheless, according to the teaching herein, methods and apparatus so adapted readily may achieved a desired result and a target correspondence.

FIG. 5 is yet another mapping, representative of possible outcomes of plural stochastic dimension process ensemble (generally at 500), which may be used to generate stochastic decision tuple sequences <δ,ρ>. However, unlike FIG. 4, in which each dimension (δᵢ, ρᵢ) can be drawn from one process, sequences representative of each dimension (δᵢ,ρᵢ) may be generated using multiple, disparate stochastic processes and drawn from multiple, disparate, distribution envelopes, yet be adaptably and controllably generated within a desired space. Stochastic process 500 may be constructed from plural subprocesses, in a building-block fashion. Such a composite process can generate controllable, quasi-deterministic outcomes that can be used to form one or more stochastic dimension sequences. The selected subprocesses of the composite stochastic process also may be stochastic in nature, and adapted to yield selected dimension portions, which generally may lie within a definable subspace. As with previously recited stochastic values, the values generated by process 500, are adapted to induce a desired behavior in a selected perceiver, such as, for example, second transactor 120, in FIG. 1, or buyer 210 in FIG. 2. The adapted values generated by process 500 may include one or both of stochastic offer value ρᵢ and stochastic offer interval δᵢ.

Stochastic offer intervals δᵢ may vary between adapted minimum offer interval δ_{L} 585 and adapted maximum offer interval δ_{U} 590, within a preselected distribution envelope, and which may be distributed about some mean interval value (not show). Likewise, stochastic offer values ρᵢ may vary between a preselected floor value [α] 515 and a preselected ceiling value [ω] 525, dispersed about adapted mean offer value μ 545, within a preselected distribution envelope. Adapted mean value μ 545 may result from implementation of adapted upper target offer value ξ 530 and adapted lower target offer value β 520, positioned between [ω] 525 and [α] 515. Similar to value ξ 430 and value β 420 in FIG. 4, it may be desirable to adapt one or both of value ξ 530 and value β 520, in response to factors of the environment in which the trading event occurs. Importantly, adapted lower target offer value β 520 and adapted upper target offer value ξ 530 may be so adapted before, during, or after a trading event.

Unlike the process 300 in FIG. 3, or process 400 in FIG. 4, stochastic process 500 in FIG. 5 is a composite process, which represents an ensemble, or defined group, of random processes ε₁, ε₂, . . . , ε_{M}. One or more sequence values <δᵢ,ρᵢ> may be generated by one or more of the ensemble of random processes ε₁, ε₂, . . . , ε_{M}. Ensemble members ε₁, ε₂, . . . , ε_{M} can be used to generate sequence values in numerous ways. In one exemplary technique, each <δᵢ,ρᵢ> stochastic decision tuple may be generated by corresponding process εᵢ, which itself may include suitable PRNG to generate values of <δᵢ,ρᵢ> using functions Q(x) and P(x), respectively. In another exemplary technique, each <δᵢ,ρᵢ> stochastic decision tuple may be generated by a randomly-selected ensemble member εᵢ, as is illustrated in FIG. 5. In certain embodiments, one ensemble member ε may be provided for each offer interval δᵢ in trading interval 502. In others, there may be fewer ensemble members ε than offer intervals δᵢ. In such a case, it is desirable to re-use ensemble member functions ε, so that member functions ε may be used multiple times to generate offer interval δᵢ together with offer value ρᵢ. In certain embodiments, it is advantageous to generate stochastic decision tuple <δᵢ,ρᵢ> in real-time, or near-real-time, as a trading event transpires. In other embodiments, it may be advantageous to generate stochastic decision tuple <δᵢ,ρᵢ> prior to the trading event. As indicated above, by applying a selected distribution function to outcomes generated by a PRNG, the boundaries and shape of the process subspace can be controlled using, for example, mean value, boundary values, and adapted target values as input for the processes of ε. Such piecewise control of the stochastic process represented by process 500, stochastic decision tuple <δᵢ,ρᵢ> values can be shaped and clustered to adapt to, and to at least weakly correspond with, an external process, which may be transpiring at least partially concurrently with process 500. Such an external process could include, for example, music, live or recorded events, and the like. Thus, according to the teachings herein, stochastic process 500 could provide stochastic decision tuple <δᵢ,ρᵢ> in a manner that allows selected values of <δᵢ,ρᵢ> remain at least quasi-stochastic and randomized, yet appear as if they bear some coordination with the external process. As before, non-limiting examples of probability distributions that may be used include, alone or in combination, Uniform, Gaussion, Cauchy, cosine, Double Gamma, Laplace, and Student's-t distributions, as well as Beta, Burr, Chi, Fisk, Log Normal, and Triangular continuous distributions, as well the gamut of suitably chosen discrete distributions.

Further to FIG. 5, trading interval 502 can begin at t₀ 505 with onset of first offer interval δ₁ 503 and continue until t₁, at which time second offer interval δ₂ 504, begins. Prior to t₀, ensemble member process ε₅ generates first stochastic decision tuple <δᵢ,ρᵢ>, which can be signaled to a selected perceiver, such as second transactor 102 in FIG. 1 or buyer 210 in FIG. 2. Generally following the signaling protocol described, for example, with respect to FIG. 2, buyer 210 perceives offer value ρ₁ and, if desirous to make a transaction with seller 205, buyer 210 signals a COMMIT response to seller 205 before offer interval δ₁ expires. Prior to the expiration of first offer interval δ₁, ensemble member process ε₃ generates second stochastic decision tuple <δ₂, ρ₂>. Should buyer 210 not respond before the end of first offer interval δ₁ or does not otherwise provide a COMMIT response, second stochastic decision tuple <δ₂, ρ₂> can be signalled to buyer 210 before first offer interval δ₁ expires. At t₁, the trade object, which is available for trading, can be offered by seller 205 to buyer 210 for second offer value ρ₂, with this value being valid for only a period of δ₂ interval 504. Prior to the end of second offer interval δ₂, ensemble member process ε₈ can generate third stochastic decision tuple <δ₃, ρ₃>, which is signaled to buyer 210 before t₂. In general, the generation of new stochastic decision tuples <δ₁, ρ₁> may repeat throughout trading interval 502, with ensemble member process ε₄ generating N^{th} decision tuple <δ_{N}, ρ_{N}> for use with N^{th} offer interval δ_{N} 595, typically terminating at t_{N} 507. Similar to process 400 in FIG. 4, offer intervals may vary substantially randomly between adapted lower bound offer interval δ_{L} 585, and adapted upper bound offer interval δ_{U} 590. In addition, a promotional decision tuple <δ_{P}, ρ_{P}> can be signaled to buyer 210 in advance of promotional offer interval δ_{P}. Promotional decision tuple <δ_{P}, ρ_{P}> may be interjected by seller 205 during the transpiration of event interval 502, or may be interjected in advance, for example, during an advanced generation of decision tuples <δ, ρ> while planning for a particular trading event. Offer intervals δ_{P} and offer values ρ_{P} may selectively be generated and presented, using composite stochastic methods herein, and used within the context of an entertainment schema. For example, in an milieu, the signaling of stochastic decision tuples <δ,ρ> can be coordinated with audio and visual indicia, including music, sounds, dramatic images, and the like, to heighten excitement and interest in a particular trading event. Buyer 210 may be induced into behaving in a desired way, for example, committing to making a trade, for a trade object offered during a trade interval, in response to perceiving the stochastic decision tuples <δ, ρ>. Process 500 may be one of many such transaction processes, which may be proceeding, whether simultaneously or serially, in which it may be desirable for seller 205 to monitor and adjust, as desired, adapted upper target offer value ξ 530 and adapted lower target offer value β 520, which may be common to at least some of these transaction processes. In this manner, seller 205 is provided with methods and apparatus to adapt the trading event milieu, such as trade object pricing and trading event pacing, to a desired range. Seller 205 also can be enabled to adapt and adjust profit margin, clearance prices, promotional events, and so on, and to differentiate trade object transactions for selected classes of buyers 210.

Exemplary implementation of certain aspects of the present invention includes a transaction system in which a stochastic decision tuple 225 is uplinked over a broadcast network and a packet-switched communications internetwork (i.e., the Internet). In one specific example, one hundred (100) digital cameras are offered over a trading interval Δ comprising 100 offer intervals δ₁₋₁₀₀ each linked to offer values ρ₁₋₁₀₀. Assuming a first digital camera is being offered at $400 if accepted over the next 3 minutes, a viewer-purchaser watching the trading event on television may quickly act on the offer, because it lower than a manufacturer's suggested retail value, by picking up a telephone and dialing seller's circuit-switched network and depressing a telephone key, such as an asterisk key to COMMIT. The first offer event may include a plurality of cameras offered at $400 over a first time interval as the audience may include a plurality of viewers or participants. However, for the sake of convenience, further discussions only relate to a single item being offered during an offer event over an offer interval although it is understood that more than one items (e.g., two or more cameras) may be offered for an offer value over an offer interval. The number of items being offered per offer interval may be established prior to the first offer interval or during the trading interval Δ_{N} with the trading event inventory or total trade object inventory being a factor.

When a second stochastic decision tuple is offered, the camera may be offered for more, if the offer interval during the prior offer hardly elapsed, for less, if the offer interval took almost the whole 3 minute period or if there was a NULL response, or for the same amount. Additionally, the offer price may remain the same, increase, or decrease. During the second trading interval, a purchaser, using the Internet, may click buy to COMMIT to the second offer.

The third through 100 cameras may proceed the same way until the entire trading event inventory is exhausted. It is possible the trading event may extend beyond 100 trading intervals if, for example, a purchaser provides a response token that includes a CANCELATION. In this case, the trading event may continue for as long as the trading event inventory remains. Alternatively, seller may chose to terminate the trading event early or right at the 100th offer.

In an exemplary embodiment, a plurality of object offers or items being offered at an offer value during an offer interval may receive a corresponding number of responses from multiple participants or vendees over a plurality of communication sources, such as the Internet, a palm PC with wireless or wireless connection, a desktop PC, a telephone, and a fax machine. Thus, aspects of the present invention include a system capable of receiving, handling, and manipulating simultaneous or substantially contemporaneous responses from multiple communication sources.

In another application of the stochastic transaction system provided in accordance with aspects of the present invention, a series of decreasing offer values are provided until the entire trading event inventory is exhausted. Thus, in the 100-camera example, a first offer value may be established within a pre-selected ceiling value, which may represent an MSRP, down to a preselected floor value, which may represent seller's cost-to-market price. As each stochastic decision tuple is offered to a plurality of purchasers, a corresponding response token is received, from a purchaser first to submit a response within the offer interval. To entice additional purchasers, a subsequent offer value and offer interval may both decrease, which will likely elicit a response as the decrease in offer value presents a saving to purchaser. The decrease in offer value and offer interval, while trending downwardly, may be random due to the stochastic nature of either or both the offer value and the offer interval, as discussed above. An earlier purchaser may rejoin the trading event by CANCELING a prior commitment. However, he or she risks missing out on a subsequent purchase due to the rapid nature of the trading event and the competition provided by other purchasers in purchasing a limited event inventory.

In an alternative embodiment, the preseleted floor value may be lower than seller's cost of goods. This situation may arise if seller is motivated to sell the entire inventory while basing profits on the average sales of the entire inventory rather than on a per transaction basis. Still alternatively, the cameras or other tangible or intangible goods of value in the trading event inventory may be calculated so that offer values corresponding to each pair of offer value and offer interval in a stochastic decision tupble fall within a pre-selected ceiling value and preselected floor value but within a smaller envelope computed from a preselected non-deterministic process. For example, the cameras may be priced or valued within an adapted upper target offer and an adapted lower target offer because, for example, they are new on the market and difficult to get. Other factors may include geopolitical factors in which additional tariffs are imposed thus making the cameras more expensive and therefore buying at a competitive price more compelling.

Although limited embodiments of the transaction and trading systems and their components have been specifically described and illustrated herein, many modifications and variations will be apparent to those skilled in the art. For example, a trading event may be limited to over the air broadcasting or CATV uplink and a telephone network downlink, and the items being offered may be other than commodities, they may include services, antiques, specialty items, collectable items, professional services, made to order items, an exchange of one item for value for another item of value, etc. Accordingly, it is to be understood that the transacting and trading systems and their components constructed according to principles of this invention may be embodied other than as specifically described herein. The invention is also defined in the following claims.

1. A trading system comprising:
a computer for establishing an offer value for an object offer, said offer value includes a quasi-stochastic tuple related to the establishment of the offer value;
a database for processing a response linked to the object offer at the offer value; and
a marketing communication link for conveying the object offer at the offer value.

2. The trading system of claim 1, wherein the marketing communication link is at least one of a broadcast network and a wide area communication network.

3. The trading system of claim 1, wherein the quasi stochastic tuple comprises a proposed offer value and an offer interval.

4. The trading system of claim 3, wherein one of the proposed offer value and the offer interval comprises a quasi-stochastic variable value.

5. The trading system of claim 4, wherein the offer interval is a quasi-stochastic variable value.

6. The trading system of claim 5, wherein the proposed offer value is a stochastic variable value.

7. The trading system of claim 6, wherein the proposed offer value is a stochastic variable value.

8. The trading system of claim 3, wherein the tuple comprises both a quasi-stochastic offer interval and a quasi-stochastic offer value.

9. The trading system of claim 1, further comprising a sequence of quasi-stochastic tuples communicated by the vendor to the vendee during a defined transaction period.

10. The trading system of claim 1, wherein a vendee accepts the object offer at a purchase value responsive to a proposed offer value comprising the selected one of the sequence of quasi-stochastic tuple.

11. The trading system of claim 3, wherein a vendor proposes the object offer to a plurality of vendees through the marketing communication link.

12. The trading system of claim 10, further comprising a sequence of quasi-stochastic tuples communicated by a vendor to a plurality of vendees during a defined transaction period.

13. The trading system of claim 12, wherein one of the plurality of vendees accepts the object offer at the purchase value responsive to a selected one of the sequence of quasi-stochastic tuples, the purchase value corresponding to a proposed offer value comprising the selected one of the sequence of quasi-stochastic tuples.

14. The trading system of claim 13, wherein selected tuples of the sequence of quasi-stochastic tuples comprise both a quasi-stochastic offer interval and a quasi-stochastic offer value.

15. The trading system of claim 1, further comprising:
an object manager adapting a selected vendor object property responsive to one of data relative to the object offer, a vendor, and a vendee; and
one of
an operations communication link coupling the vendor and the object manager, whereby the vendor and the object manager communicate data relative to the object offer; and
a commerce communication link coupling the vendee and the object manager, whereby the vendee and the object manager communicate data relative to the object offer.

16. The trading system of claim 15, wherein the vendor proposes the object offer within a preselected marketing schema.

17. The trading system of claim 16, wherein the preselected marketing schema comprises an interactive, multimedia entertainment schema.

18. The trading system of claim 1, wherein the object offer represents one of a product, a service, and a combination thereof.

19. The trading system of claim 1, comprising a marketing module including a vendor, and the marketing communication link coupling the vendor to a vendee.

20. The trading system of claim 19, comprising an operations module including the vendor, the object manager, and the operations communication link coupling the vendor and the object manager.

21. The trading system of claim 20, comprising a commerce module including the vendee, the object manager, and the commerce communication link coupling the vendee and the object manager.

22. The trading system of claim 21, wherein the commerce module adapts to an order from the marketing module, the order being one of an operations order communicated over the operations communication link from the vendor and a commerce order communicated over the commerce communication link from the vendee.

23. The trading system of claim 22, wherein the vendor proposes the object offer within an interactive, multimedia entertainment schema, and adapted to entice the vendee to receive the object offer of the vendor.

24. The trading system of claim 1,
wherein the tuple comprises a quasi-stochastic variable having a pseudorandom cardinality assigned thereof;
wherein the pseudorandom cardinality is defined in a range between about less than, and about equal to, a predetermined ceiling value, and between about equal to, and about greater than a predetermined floor value; and
wherein the quasi-stochastic variable is at least one of the offer interval and the offer value.

25. A transaction system for conducting an exchange for value comprising:
a computer terminal comprising a controller for computing a plurality of sets of offer value and offer interval for an object offer, including a first set and a second set;
wherein at least one of the offer value and offer interval within a set falls within a distribution envelope that is shaped, at least in part, by a probability distribution function; and
wherein at least one of the offer value and offer interval within a set varies from an offer value and an offer interval within a different set by a value having a randomized factor; and
a marketing communication link for receiving a first response token and a second response token linked to the first set and the second set.

26. The transaction system of claim 25, wherein the probability distribution function is defined by a quasi-stochastic tuple.

27. The transaction system of claim 26, wherein at least one of the offer value and the offer interval in a set comprises a quasi-stochastic variable value.

28. The transaction system of claim 27, wherein the offer interval is a quasi-stochastic variable value.

29. The transaction system of claim 28 wherein the offer value is a quasi-stochastic variable value.

30. The transaction system of claim 25, wherein at least one of the offer value and offer interval within a set include a pseudo-random number generation technique.

31. The transaction system of claim 1, wherein both the offer value and the offer interval within a set have a quasi-stochastic value.

32. A method for conducting a transaction comprising:
offering a first object for transacting;
computing a first offer value and a first offer interval for making the transaction involving the first object;
receiving a response for the first object;
offering a second object for transacting;
computing a second offer value and a second offer interval for making the transaction involving the second object;
facilitating the first set and the second set to be displayed on at least one of a broadcast network and a wide area communication network;
receiving a response for the second object; and
wherein at least one of the second offer value and the second offer interval differ from the first offer value and the first offer interval by a factor computed by a stochastic process.

33. The method of claim 32, wherein both the offer value and the offer interval are computed by a stochastic process.

34. The method of claim 32, wherein the second offer value is less in monetary value than the first offer value.

35. The method of claim 32, further comprising a third offer value for a third object offer and a fourth offer value for a fourth object offer, wherein the third offer value has a lower monetary value than the second offer value and the fourth offer value has a lower monetary value than the third offer value.

36. The method of claim 32, wherein the stochastic process includes a pseudo-random number generation (PRNG) technique and a probability distribution function.

37. The method of claim 36, wherein the PRNG technique produces a distribution envelope and wherein the probability distribution function shapes the distribution envelope.

38. The method of claim 36, wherein the probability distribution technique comprises at least one of a weighted distribution, a skewed distribution, a multimodal distribution, and a composite distribution.

39. The method of claim 32, wherein the first offer value and the second offer value fall within a preselected ceiling value and preselected floor value.

40. The method of claim 32, wherein the first offer value and the second offer value fall within an adapted upper target offer value and an adapted lower target offer value.

41. The method of claim 40, wherein at least one of the adapted upper target offer value and an adapted lower target offer value varies between the first offer interval and the second offer interval.

42. The method of claim 40, further comprising the step of sending a response directed to the first object.
